(19) United States
(12) Patent Application Publication
(10) Pub. No.: US 2008/0052029 A1
(43) Pub. Date: Feb. 28, 2008

(54) Unique binary identifier using existing state elements

(75) Inventors: Robert B. Benware, Clackamas, OR (US); Mark A. Ward, West Linn, OR (US); Christopher W. Schuermyer, Troutdale, OR (US)

Correspondence Address: LSI CORPORATION, 1621 BARBER LANE, MS: D-106, MILPITAS, CA, 95035, US

(73) Assignee: LSI LOGIC CORPORATION, Milpitas, CA (US)

(21) Appl. No.: 11/466,846

(22) Filed: Aug. 24, 2006

(51) Int. Cl. G06F 19/00; G06F 17/50

(52) U.S. Cl. 702/117; 716/1; 702/108

(57) ABSTRACT

A method of retrieving a unique, repeatable identification value from an integrated circuit by identifying a plurality of state elements within the integrated circuit, where the state elements are part of standard functional circuitry within the integrated circuit, and are not part of a specialized circuit designed to primarily produce the unique, repeatable identification value, performing an initializing process on the state elements to bring the state elements to repeatable states, where the repeatable states of different state elements are dependent at least in part on differences between the different state elements, reading the repeatable states on the state elements, and joining the repeatable states into a binary number as the unique, repeatable identification value.

### FIELD

This invention relates to the field of integrated circuit fabrication. More particularly, this invention relates to uniquely identifying integrated circuits.

### BACKGROUND

Integrated circuits have evolved into enormously complex devices, which are fabricated by equally complex processes. As the term is used herein, “integrated circuit” includes devices such as those formed on monolithic semiconducting substrates, such as those formed of group IV materials like silicon or germanium, or group III-V compounds like gallium arsenide, or mixtures of such materials. The term includes all types of devices formed, such as memory and logic, and all designs of such devices, such as MOS and bipolar. The term also comprehends applications such as flat panel displays, solar cells, and charge coupled devices.

Integrated circuits are typically processed in a wafer form on a common semiconducting substrate, which substrate typically holds something in the neighborhood of several hundred individual integrated circuits, depending on die size and wafer size. A variety of information on the processing of the substrate is typically recorded in a database. Thus, while the integrated circuits are in wafer form, it is relatively easy to look back upon the recorded processing history for the integrated circuits, by first identifying the substrate upon which the integrated circuits reside, and then accessing the information for the substrate. Such information can be very useful in determining the causes of problems that might be noticed at a later point in the fabrication cycle.

However, once the individual integrated circuits are singulated and packaged, it might be impossible to determine the substrate from which a given integrated circuit was taken, and the processing that the substrate received. However, for a variety of different reasons, such information could be extremely useful. For example, determining the processing given an integrated circuit that failed in the field could help prevent additional future failures for the same cause.

What is needed, therefore, is a system that overcomes problems such as those described above, at least in part.

### SUMMARY

The above and other needs are met by a method of retrieving a unique, repeatable identification value from an integrated circuit by identifying a plurality of state elements within the integrated circuit, where the state elements are part of standard functional circuitry within the integrated circuit, and are not part of a specialized circuit designed to primarily produce the unique, repeatable identification value, performing an initializing process on the state elements to bring the state elements to repeatable states, where the repeatable states of different state elements are dependent at least in part on differences between the different state elements, reading the repeatable states on the state elements, and joining the repeatable states into a binary number as the unique, repeatable identification value.

In this manner, not only is there a unique, repeatable identification value available for each such integrated circuit, but valuable space on the integrated circuit does not need to be consumed with circuitry that is primarily used for the identification circuitry. Instead, the standard, functional circuitry of the integrated circuit is used to produce the unique, repeatable identification value. In various embodiments, the differences between the different state elements comprise threshold voltage. The state elements in some embodiments are at least one of memory cells, flip flops, and JTAG boundary scan cells.

According to another aspect of the invention there is described a method of retrieving a unique, repeatable identification value from an integrated circuit by identifying a state element within the integrated circuit, where the state element is a part of standard functional circuitry within the integrated circuit, and is not part of a specialized circuit designed to primarily produce the unique, repeatable identification value, performing an initializing process on the state element to bring the state element to a repeatable state, reading the repeatable state on the state element, and iteratively applying additional, set processes to the state element and reading the state on the state element to produce the unique, repeatable identification value.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a circuit diagram of one embodiment of an existing state element for use in a chip identification circuit.

FIG. 2 is a flow diagram for obtaining a unique binary identifier from existing state holding elements.

### DETAILED DESCRIPTION

According to the present invention, existing state elements within the design of an integrated circuit are selectively used to produce a repeatable, substantially random series of preferably binary digits that is used as an identification for the integrated circuit. The random nature of the series is produced by subjecting one or more state elements to a specific protocol of voltage or frequency fluctuations. Small differences in the state elements from one integrated circuit to another cause the identification to differ from one integrated circuit to another. These small differences are caused by slight and minute differences in materials and processing that are used during the fabrication of the integrated circuits, even as between integrated circuits that are fabricated on the same wafer. While these differences in the state elements, such as voltage threshold, are typically too small to cause a given integrated circuit to malfunction or not perform according to specification, they can be used for the purposes as described herein.

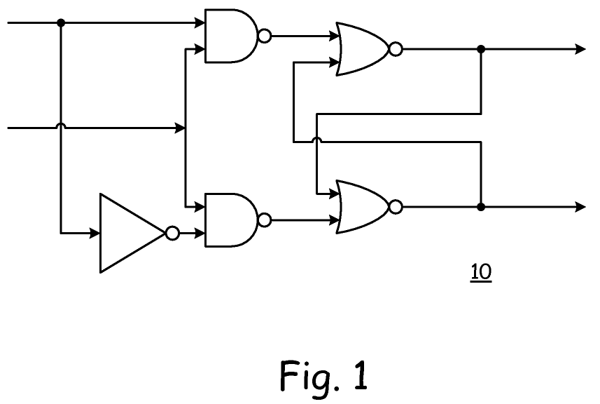

With reference now to FIG. 1, there is depicted a circuit diagram of a digital flip flop 10, which serves as an example of a state element. Such flip flops 10 are typically extensively used in integrated circuit design, and thus there would be no need to add such circuitry to an integrated circuit design in order to utilize the circuit 10 as an identification circuit as described herein.

It is appreciated that the flip flop 10 is merely one example of a state element, or in other words, a state holding device, and that any such state element could be used as a part of the preferred embodiments of the invention as described herein. For example, any accessible storage element will suffice if it can be stated properly. Some examples are scan flip-flops, memory arrays, and JTAG boundary scan cells.

Advances in structural testing of integrated circuits have made it possible to gain direct access to these state elements. Specifically in the case of the flip flops 10, it is routine to daisy chain these elements into what is called a scan chain. Binary streams of data can be shifted into and out of these scan chains, making it possible to access the binary state of any given flip flop in the design.

In standard CMOS technology, flip flops 10 are created using a feedback network such as that shown in the logic diagram of FIG. 1, for example. The initial state of the flip flop 10 upon power up is in part determined by the individual transistor threshold voltages that are involved in the feedback network. Local threshold voltage variations that are essentially random in nature will dictate the power up state of each flip flop 10, which results in a unique bit state in these elements. The test scan chain structure enables the bit stream signature to be shifted out and recorded, thus producing the identification value of the integrated circuit.

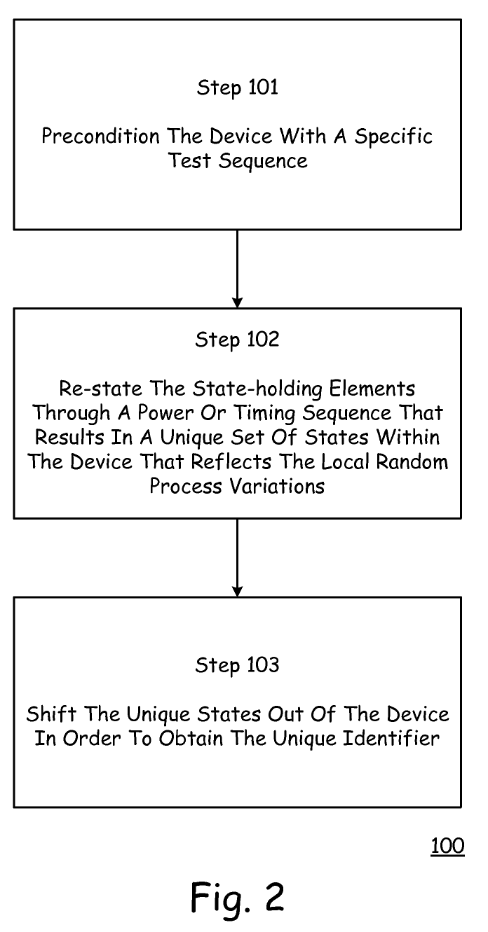

The method 100 of using the state elements to obtain a unique device identifier is depicted in FIG. 2. In step 101, the state element is preferably preconditioned either in a powered up or powered down mode. The preconditioning tends to ensure that the state of the element after step 102 is most repeatable. The preconditioning preferably includes applying states to the inputs of the device, as well as shifting known values into the state elements.

In step 102, a power sequence is preferably followed that results in the states changing in a manner according to the specific processing that the devices in the state element have undergone. This sequence can be either very simple or more complex. On the simple end, the sequence can be a full power down where supply voltage is taken fully to zero volts, followed by a full power up. On the more elaborate end, it can be a sequence of partial power down and time dependant power up ramps, for example. All such power sequences are anticipated.

In step 103, under full power up conditions, the modified binary data is accessed via scan chains or other structural approaches to obtain the unique device identifier.

Another variation is the way in which the part is stated. Any way that random values can be applied to the state elements will generate a unique signature. Some examples are powering the part up from an off-state, and reducing the voltage at a known state.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of retrieving a unique, repeatable identification value from an integrated circuit, the method comprising the steps of:
identifying a plurality of state elements within the integrated circuit, where the state elements are part of standard functional circuitry within the integrated circuit, and are not part of a specialized circuit designed to primarily produce the unique, repeatable identification value,
performing an initializing process on the state elements to bring the state elements to repeatable states, where the repeatable states of different state elements are dependent at least in part on differences between the different state elements,
reading the repeatable states on the state elements, and
joining the repeatable states into a binary number as the unique, repeatable identification value.

2. The method of claim 1, wherein the differences between the different state elements comprise threshold voltage.

3. The method of claim 1, wherein the state elements comprise at least one of memory cells, flip flops, and JTAG boundary scan cells.

4. A method of retrieving a unique, repeatable identification value from an integrated circuit, the method comprising the steps of:
identifying a state element within the integrated circuit, where the state element is a part of standard functional circuitry within the integrated circuit, and is not part of a specialized circuit designed to primarily produce the unique, repeatable identification value,
performing an initializing process on the state element to bring the state element to a repeatable state,
reading the repeatable state on the state element, and
iteratively applying additional, set processes to the state element and reading the state on the state element to produce the unique, repeatable identification value.
